(19) United States
(12) Patent Application Publication
(10) Pub. No.: US 2011/0024660 A1
(43) Pub. Date: Feb. 3, 2011

(54) Angle-seating butterfly vane and method for producing the same

(76) Inventor: Hans D. Baumann, West Palm Beach, FL (US)

Correspondence Address: HANS D. BAUMANN, UNIT 1405, 801 S. OLIVE AVE., WEST PALM BEACH, FL, 33401, US

(21) Appl. No.: 12/462,047

(22) Filed: Jul. 29, 2009

(51) Int. Cl. F16K 1/22

(52) U.S. Cl. 251/306

(57) ABSTRACT

The invention relates to vanes used in butterfly valves utilized in fluid control systems requiring special relationships between passing fluid and vane rotation and furthermore can provided leak proof shut-off when in the closed valve position. My invention furthermore features a shape that greatly reduces the customary high dynamic torque created by fluid suction effects on a vane when in the open position.

### BACKGROUND OF THE INVENTION

The invention describes an angle-seating vane typically employed as shut-off or fluid throttling device in an elastomer lined butterfly valve. Butterfly valves of this kind usually employ flat and axis symmetric vanes to provide shut-off when squeezed into a vertical position perpendicular to the axis of the valve passage. Such vanes have a slightly larger diameter than that of the passage causing some of the elastomeric liner to be displaced. Such a system works well for valves only requiring on-off service but are not practical for throttling or modulating service since the diametrical interference produces substantial friction resulting in a jerky action tending to upset a smooth fluid control.

Furthermore, repeated closures can lead to abrasive wear of the liner causing eventual leakage. Finally, flat butterfly disks or vanes are subject to substantial dynamic torque due to the suction effect imposed by the fluid on that portion of the vane facing downstream. Such high torque can lead to instability and requires strong and costly actuating devices to overcome.

My invention overcomes these and other objections, by providing a vane that does not rely on diametric interference between vane and liner. This is accomplished by assuring shut-off through gentle touching of the liner by the outer rim of my vane at an angle whose tangent is larger than the coefficient of friction between the metal vane and the elastomer liner material, thus assuring a gentle opening action.

Furthermore, my vane has a cup-shaped opening on the half portion facing downstream. This breaks up any suction effect by the passing fluid assuring a greatly diminished hydraulic torque effect.

The flat outer rim around a portion of the circumference provides a gripping surface in order to facilitate a turning by a lathe or other machinery in order to machine a required precise diameter of my vane when in a tilted position.

This design is especially suitable for applications in the bioprocess industries requiring a germ free environment. This is possible since my vane has no opening for the collection of germs or impurities (except for the shaft passage which is sealed on either end). This is in contrast to the design shown in my U.S. Pat. No. 3,469,305. Here the shaft is exposed to fluid at the center portion of the vane. Such an opening is necessary to accept a turning fixture for machining. My invention solves this problem by clamping the vane at the inside of the external rim.

Another advantage over my former patent is the fact that my new vane has a much more gradual opening flow characteristic. My vane has an elongated contact area with the valve's passage ending about 5 degrees from the vertical axis. Any 5 degree turn from the closed position will yield a flow area proportional to 1−cosine (5+5 degrees)=0.016 times the radius of the valve's passage. In contrast, the former vane had a contact angle of 15 degrees. Here a 5 degree turn will produce a gap proportional to 1−cosine (5+15)=0.06 time the radius of the passage. This is an almost 4 times improvement over the prior art.

There are a number of prior arts patents having vanes in order to reduce dynamic operating torque; examples are U.S. Pat. No. 2,271,390 by Dodson and German patent 2430821 by Maug. While the Maug patent lacks the improved flow characteristic feature and machinability features of my invention, Dodson's vane cross-section is excessive by providing special dynamic profiles. This limits the valve's flow capacity severely when in the open position. Furthermore gradual opening is only partially achieved since its seating points at 16 has a starting angle of about 15 degrees. Brown, U.S. Pat. No. 2,278,421 has a similar problem since one half of his vane seats at about 45 degrees which makes for an even more rapid opening sequence.

My U.S. Pat. No. 6,726,176 shows a more modern version of a tight shut-off butterfly valve employing a double eccentric vane. Here a desirable characteristic is achieved by utilizing a contoured portion as part of the vane and in the valve housing itself. Such solutions are impossible in lined or sanitary butterfly valves. My latest patent also shows a cupped recess in order to reduced dynamic torque (see FIG. 5-86). Its effectiveness is limited by the near flat surfaces between the upper and lower seats. In my invention, the fluid is guided into a recess by the upper half which is tilted downstream. Finally, this referenced invention lacks the machinability feature provided in my current invention provided for by the upper and lower recesses.

### BRIEF DESCRIPTION OF THE DRAWINGS

FIG. 1 is an external view of a preferred embodiment of my invention.

FIG. 2 is a cross-sectional view of the embodiment shown in FIG. 1 when installed in a lined butterfly valve.

FIG. 3 is a planary view of the preferred embodiment of FIG. 1.

FIG. 4 is a graphic presentation of the relationship between flow (Q) and percent of vane travel, comparing that of the invention (a) against that of a conventional angle seating butterfly valve (b).

### DETAILED DESCRIPTION

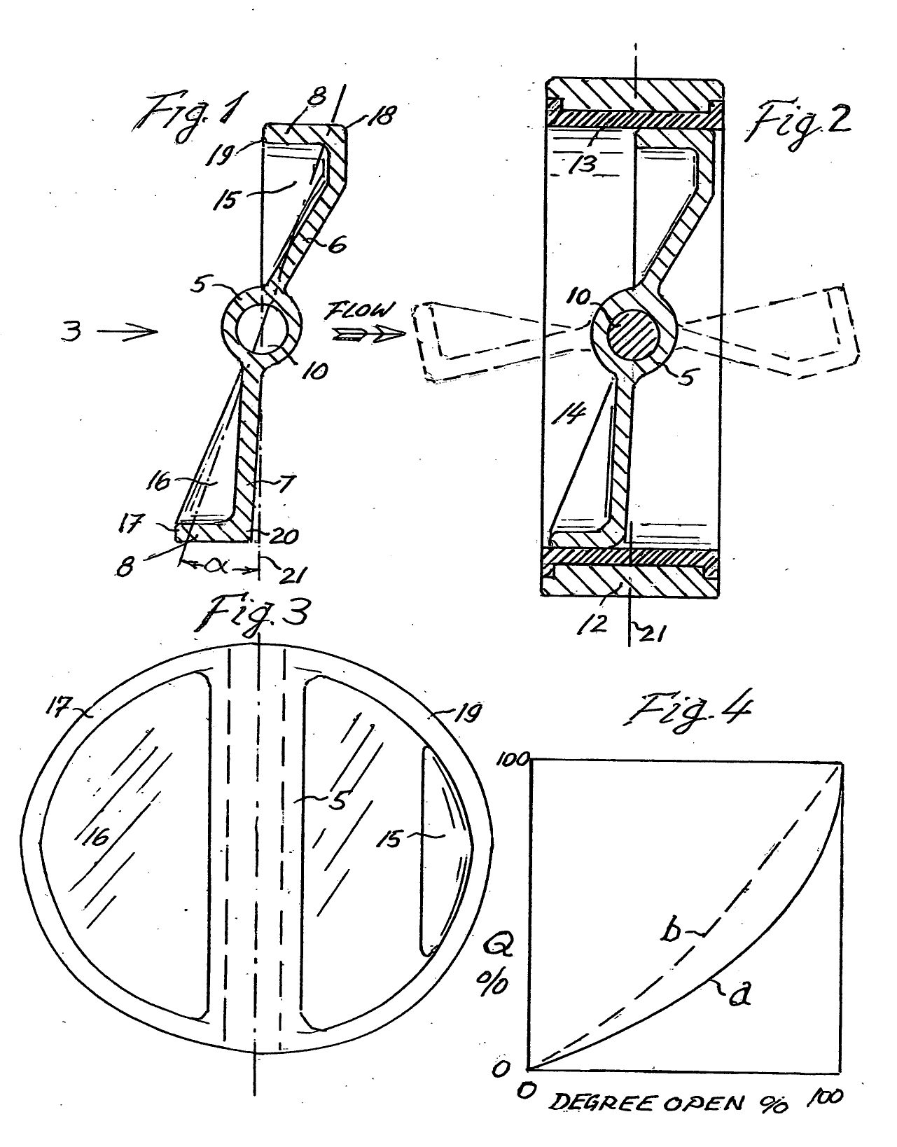

Referring to FIG. 1, where a preferred version of my vane is illustrated, it is comprised of a central hub 5 joined by an upper disk 6 and a lower disk 7 connected to a rim 8 extending along a substantial portion of the circumference of my vane. The width of this rim diminishes in length from about 15% to 18% of the max. cross-section of the vane to zero near the hub. The hub 5 has a central, circular bore 9 capable of receiving a shaft 10.

FIG. 2 shows the embodiment of FIG. 1 in a cross-sectional view when installed in a conventional elastomer lined butterfly valve 12. Here my vane is shown when the valve is closed and where the upper and lower rim portions 8 contact the inner bore 13 of the valve passage 14. The extreme corners of rims 8 contact the liner 13 at an angle α of between 15 and 20 degrees, an angle whose tangent exceeds the coefficient of friction between the liner material and that of the vane, thus resulting in a smooth disengagement of the vane from the liner.

It should be noted, that disk portion 6 is tilted against the lower disk portion 7 thereby creating a recess 15. The purpose is twofold, first, the recess or pocket 15 will create an impingement for fluid flow, when the vane is in the open position (see dotted outline in FIG. 2). This will eliminate the suction effect on the upper halve of the vane normally responsible for high dynamic torque associated with conventional butterfly vanes. Secondly, recess 15, together with a similar recess 16 in the lower half of my vane enable a gripping fixture to allow holding a cast vane in the angular position dictated by angle α, in order to machine a perfect circular diameter corresponding to the bore of liner 13. This will avoid adding other protrusions or opening to the vane that would otherwise reduce fluid flow, add weight, and make polishing for bioprocessing purposes difficult.

FIG. 3 shows my invention when viewed along axis 3 in FIG. 1. This Figure clearly shows the ovalized shape of the vane when tilted up right and illustrated the difficulty in the machining process.

The vane will gradually allow fluid to pass once the seating angle α is exceeded. Here the leading edges 17 and 18 will lift fairly rapidly from the liner, while the trailing portions of the rim 19 and 20 slide in a more parallel fashion being close to the vertical centerline 21 of the valve 12. The result is a much more gradual flow characteristic identified as “a” in FIG. 4. A conventional angle-seating butterfly valve in contrast exhibits a more rapid opening coming close to a linear shape as depicted in line “b” in FIG. 4. It should be noted that while the upper disk halve 6 is tilted, the lower halve is essentially straight and parallel to the vertical valve axis 21.

While my invention has been demonstrated in a preferred embodiment, nothing shall preclude from making additional modifications without departing from the scope of the following claims. For example, it is anticipated that my vane can just as well be used in conjunction with a butterfly valve having a metallic bore instead of a liner. Furthermore, my vane could be enveloped into a corrosion resisting plastic such as Teflon®.

I claim:

1. A vane for angle-seating butterfly valves comprising a disk being tilted between 10 and 20 degrees from an axis perpendicular to the axis of the butterfly valve passage, yielding an oval planary surface, said disk having a hub extending through the central section and receiving therein a shaft suitably connected to said hub to convey rotating motion to said disk, a rim extending around a substantial portion of the outer circumference of the disk and diminishing in width towards said hub when facing away from the tilted surfaces of said disk, the outer circumference of said rim being identical with that of the disk and capable of sealingly contacting the inner surface of a butterfly valve passage in order to affect shut off.

2. A vane for angle-seating butterfly valves as in claim 1, wherein the maximum extended length of said rim is 18% of the maximum width of said vane.

3. A vane for angle-seating butterfly valves as in claim 1, wherein the planary surface of the portion of the disk located below said hub is canted in respect to the planary surface of the portion located above the hub.

4. A vane for angle-seating butterfly valves as in claim 1, wherein said vane is capable to be installed inside the passage of a butterfly valve and able to close the circular passage of said valve when rotated to a position within 65 to 80 degrees of the axis of the circular passage.

5. A vane for angle-seating butterfly valves as in claim 1, wherein the external circumferential surface of said vane is parallel with the internal surface of a butterfly passage, when the vane is in the closed position.

6. A vane for angle-seating butterfly valves as in claim 3, wherein one of the tilted planary surfaces of said disk together with a portion of said extended rim form a cup shaped void creating an impingement for fluid passing when the vane is in the open position within the valve passage.

7. A vane for angle-seating butterfly valves as in claim 3, wherein the portion of the disk located below the hub is essentially aligned perpendicular to the axis of the valve's flow passage when in the closed position.
